(19) United States
(12) Patent Application Publication
(10) Pub. No.: US 2019/0199427 A1
(43) Pub. Date: Jun. 27, 2019

(54) SYSTEM AND METHOD FOR PROVIDING SPECTRALLY EFFICIENT VOICE COMMUNICATION IN WIRELESS AND SATELLITE COMMUNICATION NETWORKS

(71) Applicants: Gaguk ZAKARIA, College Park, MD (US); Channasandra RAVISHANKAR, Clarksburg, MD (US)

(72) Inventors: Gaguk ZAKARIA, College Park, MD (US); Channasandra RAVISHANKAR, Clarksburg, MD (US)

(73) Assignee: Hughes Network Systems, LLC, Germantown, MD (US)

(21) Appl. No.: 15/854,283

(22) Filed: Dec. 26, 2017

(51) Int. Cl. H04B 7/185; H04L 12/741; H04L 29/06

(52) U.S. Cl. CPC H04B 7/18513; H04L 69/16; H04L 69/22; H04L 45/74

(57) ABSTRACT

A system and method for carrying Voice over LTE network (VoLTE) is described. The method includes: providing a dedicated channel between a user terminal and a gateway; associating the dedicated channel of a voice communication with a header context; receiving a packet comprising a voice payload of the voice communication over the dedicated channel, wherein the packet does not include the header context; selecting an associated header context based on the dedicated channel; generating a header based on the header context; and sending an IP standard packet comprising the header and the voice payload to a terrestrial network device. Another method receives a voice payload with a header and forwards the voice payload without the header over a dedicated channel associated with information in the header.

### FIELD

A system and method to carry Voice over LTE network (VoLTE) efficiently is disclosed. Various overhead data portions are removed at a transmit side for VoLTE traffic such that mostly, or in some cases only, core frame bits are carried over-the-air (OTA). Overheads data portions are re-inserted at a receiving end.

### BACKGROUND

In voice communications over LTE network (VoLTE), voice packet is carried as IP data since Long Term Evolution (LTE) is all IP network. In an IP network, RTP/UDP/IP headers (overhead) are added to the voice packet.

In the prior art, a protocol stack of a User Terminal (UT) and an eNodeB, both, include a PDCP layer, a Radio Linking Control (RLC), a Media Access Control (MAC) and a Physical (PHY) layers. A layer in a UT communicates with a corresponding layer in the eNodeB (eNB), and vice-versa.

FIG. 1 illustrates a prior art Adaptive Multi Rate (AMR) frame structure where padding bits have been added to make an AMR packet byte-aligned.

A prior art Adaptive Multi Rate (AMR) frame structure 100 includes an AMR header 102, an AMR Aux Information 110, an AMR core frame 120, and padding bits (not shown) (to byte-align an AMR frame). The AMR header 102 includes a 4-bit frame type 104, and a 1-bit frame quality indicator 106. The AMR Aux information 110 includes a 4-bit mode indicator 112, a 4-bit mode request 114 and an 8-bit codec CRC 116. The AMR core frame 120 includes Class A bits 122, Class B bits 124 and Class C bits and 26. The AMR frame structure 100 of FIG. 1 is used in AMR-Wideband (AMR-WB) and AMR-Narrowband (AMR-NB) AMR vocoders. In the AMR frame structure 100 only the AMR Core Frame 120 is the encoded voice bits; all other structures in the AMR frame structure 100 are overhead. AMR vocoders are variable rate coder where the rate can change on the fly depending on the characteristic of the voice signal. AMR vocoder rate can also change upon request when the transmission link quality changes. When the transmission link degrades, the rate may be reduced and if the link improves, the rate may be upgraded.

The 3GPP standard provides Robust Header Compression (RoHC) to compress a RTP/UDP/IP header. However, RoHC does not remove the RTP/UDP/IP header completely. RoHC uses a progressive compression where the compression gain increases over time, i.e. the overall packet size decreases over time. From time to time, the full RTP/UDP/IP header might be transmitted to refresh the RoHC context. Hence the bandwidth allocation over-the-air should be sized to handle the voice packet with a full header. Furthermore, an AMR header and auxiliary information are carried over the air even with use of RoHC.

Additional overheads of VoLTE include a RTP/UDP/IP header, AMR header, AMR auxiliary information and padding bits. As such, the overheads cause inefficiencies in transport of VoLTE at least by increasing the bandwidth utilization in at least an over-the-air (OTA) link. These overheads are not desired for mobile satellite communication or wireless communication. The addition of RTP/UDP/IP header increases the size of the voice packets significantly. For example, AMR-WB rate 6.6 kbps encoder will generate 132 bits every 20 ms. Additional 40 bytes (320 bits) RTP/UDP/IPv4 header or 60 bytes (480 bits) RTP/UDP/IPv6 header will increase the packet size for about 340% and 460% respectively.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings disclose a method that includes: providing a dedicated channel between a user terminal and a gateway; associating the dedicated channel of a voice communication with a header context; receiving a packet comprising a voice payload of the voice communication over the dedicated channel, wherein the packet does not include the header context; selecting an associated header context based on the dedicated channel; generating a header based on the header context; and sending an IP standard packet comprising the header and the voice payload to a terrestrial network device.

The present teachings disclose a method that includes: providing a dedicated channel between a user terminal and a gateway; associating the dedicated channel of a voice communication with a header context; receiving an IP standard packet comprising a header and a voice payload from a terrestrial network device; selecting a selected dedicated channel from the dedicated channel based on the association between the header and the header context; updating the header context based on the header; and sending a packet comprising the voice payload over the selected dedicated channel, wherein the packet does not include the header.

The present teachings disclose a method that includes: a gateway; and a dedicated channel for voice communication connected to the gateway. In the system, the gateway associates the dedicated channel with a header context, receives a packet comprising a voice payload of the voice communication over the dedicated channel, wherein the packet does not include the header context, selects an associated header context based on the dedicated channel, generates a header based on the header context, and sends an IP standard packet comprising the header and the voice payload to a terrestrial network device.

The present teachings disclose a method that includes: a gateway; and a dedicated channel for voice communication connected to the gateway. In the system, the gateway associates the dedicated channel with a header context, receives an IP standard packet comprising a header and a voice payload from a terrestrial network device, selects a selected dedicated channel from the dedicated channel based on an association between the header and the header context, updates the header context based on the header, and sends a packet comprising the voice payload of the voice communication over the selected dedicated channel, wherein the packet does not include the header.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail using the accompanying drawings.

FIG. 1 illustrates a prior art Adaptive Multi Rate (AMR) frame structure where padding bits have been added to make an AMR packet byte-aligned.

FIG. 2A illustrates a Spectrally Efficient VoLTE (SE-VoLTE) system over a mobile satellite network, according to various embodiments.

FIG. 2B illustrates a Spectrally Efficient VoLTE (SE-VoLTE) backhaul system including a mobile satellite network, according to various embodiments.

FIG. 3A illustrates a process illustrating a voice path from an encoder to a decoder using the SE-VoLTE protocol, according to various embodiments.

FIG. 3B illustrates a rate change in a return (UL) link, according to various embodiments.

FIG. 3C illustrates a rate change in a forward (DL) link, according to various embodiments.

FIG. 4 illustrates an exemplary context initialization of a header context at a receiver with information provided by a sender, according to various embodiments.

FIG. 5 illustrates an exemplary SIP call flow for an originating UT, according to various embodiments.

FIG. 6 illustrates an exemplary SIP call flow for a terminating UT, according to various embodiments.

FIG. 7 illustrates a UT handover from a terrestrial network to a Satellite Network according to various embodiments.

FIG. 8 illustrates a UT handover from a Satellite Network to a terrestrial network.

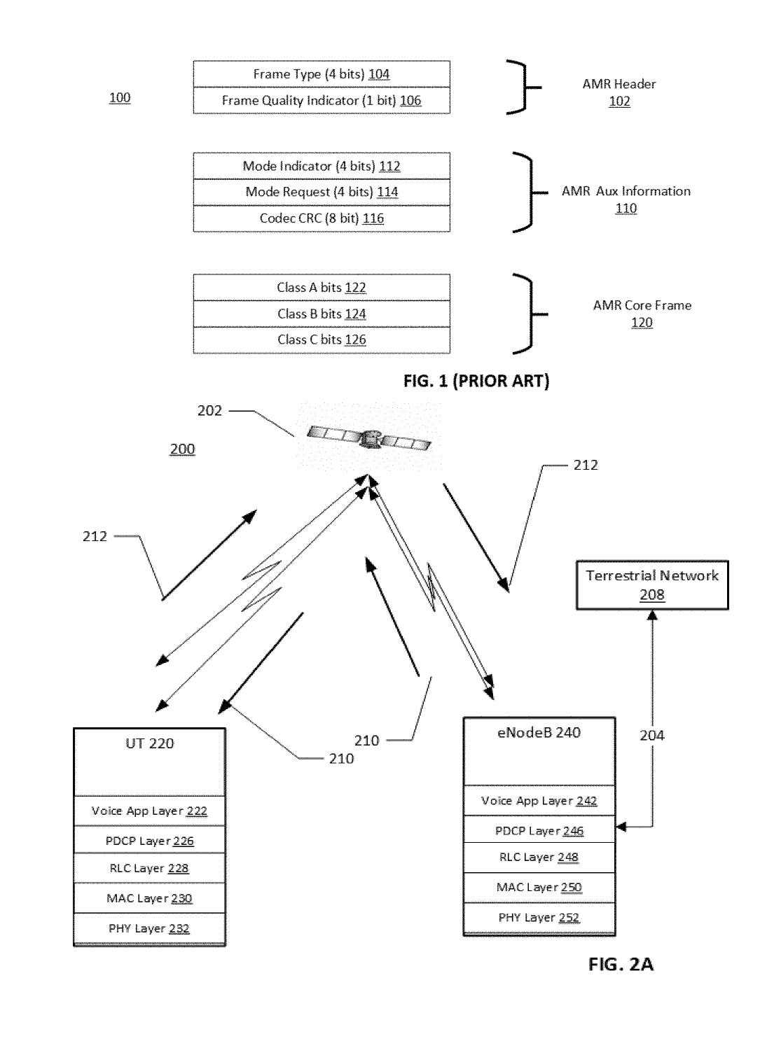

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Embodiments are discussed in detail below. While specific implementations are discussed, this is done for illustration purposes only. A person skilled in the relevant art will recognize that other components and configurations may be used without parting from the spirit and scope of the subject matter of this disclosure.

The terminology used herein is for describing embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity but rather denotes the presence of at least one of the referenced item. The use of the terms “first,” “second,” and the like does not imply any order, but they are included to either identify individual elements or to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

This disclosure describes systems and methods to efficiently carry voice communication over a LTE network (VoLTE) Over-the-Air (OTA) using Spectrally Efficient VoLTE (SE-VoLTE). In an SE-VoLTE system, only an Adaptive Multi Rate (AMR) core frame bits are carried over-the-air, and overheads are removed at a transmit side. The removed overheads are re-inserted at a receiving end. The AMR codec includes at least an AMR Narrowband (AMR-NB) codec and an AMR Wideband (AMR-WB) codec.

Vocoders at lower rates than AMR vocoders are referred to as Satellite Adaptive Multi Rate (SAMR) vocoders herein. The present teachings address both AMR and SAMR vocoders. However, unlike AMR codecs, SAMR vocoders transmit a much smaller header or overhead. When a SAMR codec is used for SE-VoLTE, only the RTP/UDP/IP header is removed, i.e. not transmitted over the satellite link.

The present teachings describe how a vocoder rate be changed either at the forward link or return link. The rate change at the forward link or return link can be done independently. The present teachings describe how to restrict the supported AMR rates when a target system only supports sub-set of AMR rates.

3GPP 4G LTE recommends that all user data including voice packet be encrypted. The encryption and decryption are done in a PDCP layer. The PDCP provides an encryptor an input parameter to encrypt voice packet and a decryptor an input parameter to decrypt the encrypted voice packet. One of the input parameters is COUNT. The input parameter COUNT is derived from a PDCP sequence number (SN) carried by the PDCP header. In some embodiments, the PDCP header can be removed before the transmission and re-introduced at the receiving end. When a transmitter uses a Time Division Multiplexing Access (TDMA) frame number in satellite communications, the PDCP SN for each voice packet may be derived from the TDMA frame number. Hence the COUNT is based on the TDMA frame number. The PDCP in the receive side may infer the PDCP SN from the TDMA frame number. The present teachings describe how to remove the PDCP header from the voice packet prior to transmission over a satellite link.

In standard 3GPP VoLTE, by using RoHC, RTP/UDP/RTP header is gradually compressed up to a maximum compression gain which is one or two bytes. However, RoHC from time to time needs to refresh the compression context by sending the full RTP/UDP/IP header. The present teachings provide systems and methods where the RTP/UDP/IP header is completely removed from the first packet on the return link and on the forward link. The RTP/UDP/IP header is re-created at the receiving end. When the SE-VoLTE uses an AMR or SAMR codec, the RTP/UDP/IP header is removed prior to transmission, and recreated by the receiver.

The present teachings improve the efficiency of SE-VoLTE using an AMR codec or a SAMR codec over satellite link in several ways. For example, the RTP/UDP/IP header is completely removed from the first packet on, not gradual reduction like RoHC. Encryption and decryption of voice packet can be achieved without sending the PDCP header that is needed in current 3GPP standard to decrypt the VoLTE voice packet. Lastly, SE-VoLTE allows for fixed, rather than variable, OTA bandwidth allocation. In addition, for a AMR codec, the AMR Header, auxiliary information, padding bits are removed prior to transmission, and only the AMR core frame is transmitted over-the-air.

With the present teachings, as the voice packet is transmitted without headers, a receiver may identity a transmitter by inference, for example, the identity of transmitter is obtained by creating a dedicated channel between the transmit and receive sides. The transmit side communicates a voice packet on an assigned time slot in a dedicated channel that is known by the receiver.

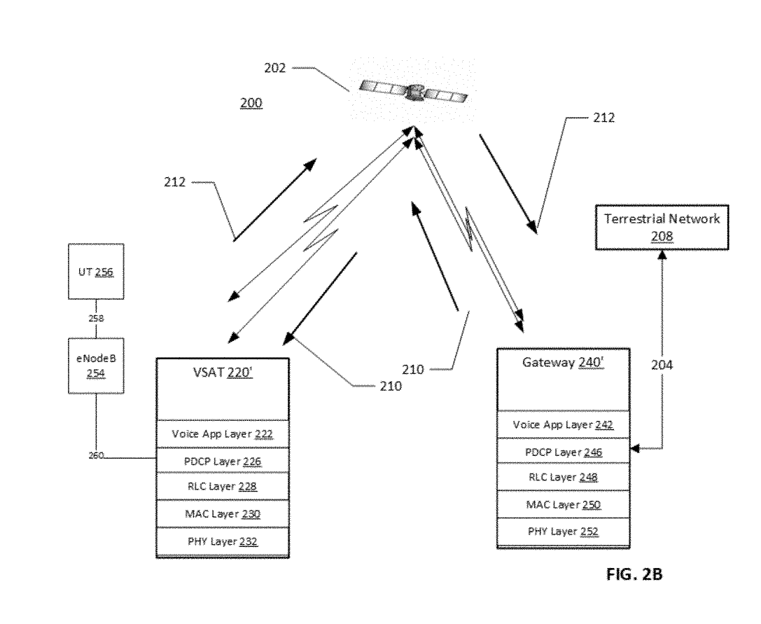

FIG. 2A illustrates a Spectrally Efficient VoLTE (SE-VoLTE) system including a mobile satellite network, according to various embodiments.

FIG. 2A illustrates a Spectrally Efficient VoLTE (SE-VoLTE) system 200 including a satellite 202, a UT 220 communicating over the satellite 202 with an eNodeB 240. The eNodeB 240 communicates with a terrestrial network 208 via a link 204 using packets that include industry standard headers like RTP/UDP/IP and AMR headers and the like. A forward link 210 communicates data from the eNodeB 240 to the UT 220 via the satellite 202. A return link 212 communicates data from the UT 220 to the eNodeB 240 via the satellite 202. Voice traffic is communicated over the forward link 210 and the return link 212 in the SE-VoLTE protocol. The UT 220 may include a voice application layer 222, a PDCP layer 226, a RLC layer 228, a MAC layer 230 and a PHY layer 232. The eNodeB 240 may include, a PDCP layer 246, a RLC layer 248, a MAC layer 250 and a PHY layer 252. The Voice application layer 222, 242 include a voice encoder and a voice decoder. The Voice application layer 222 receiver communicates with the voice application layer codec 242 sender. The Voice application layer codec 222 sender communicates with the Voice application layer codec 242 receiver.

A Voice application layer, for example, the Voice application layer 222 and 242, may be disposed at two end-points, of an OTA voice communication channel, for example, the UT 220 and the eNodeB 206. In exemplary embodiments, the Voice application layers 222 and 242 may support the AMR-NB, AMR-WB, SAMR or the like codecs. In exemplary embodiments, the UT 220 may include or be replaced by a Very Small Aperture Terminal (VSAT). In some embodiments, the eNodeB 240 may include or be replaced by a satellite gateway. In some embodiments, the SE-VoLTE codecs 222 and 242 may be disposed in or near the satellite gateway.

Exemplary OTA voice channels include dedicated channels on the forward link 210 and the return link 212. On the forward link 210, the PDCP layer 246 at eNodeB 240 may remove an AMR header, AMR auxiliary bits and a RTP/UDP/IP header from a voice payload before sending the voice payload to the UT 220. PDCP 226 at UT 220 may re-create the AMR header, the AMR auxiliary bits and the RTP/UDP/IP header before forwarding the header and the voice payload to the voice application layer 222.

On the return link 212, the PDCP layer 226 at the UT 220 may remove the AMR header, the AMR auxiliary bits and the RTP/UDP/IP header from the voice payload before sending the voice payload to the eNodeB 240. The PDCP layer 246 at the eNodeB 240 may re-create the AMR header, the AMR auxiliary bits and the RTP/UDP/IP header before sending the header and the voice payload to the voice application layer 242 in the terrestrial network 208.

On the forward link 210 and the return link 212, the AMR or voice payload is reduced since the AMR header and the padding bits can be re-created at a respective PDCP receive side (226 or 246), as described herein. In exemplary embodiments, a voice frame size can be set to 20 ms or 40 ms, i.e., a voice packet can be sent every 20 ms or every 40 ms.

Without limitation, with the present teachings, a voice communication may achieve at least the same link efficiency as a circuit switch channel over the air.

### SE-VOLTE on Cellular Backhaul Over Satellite

FIG. 2B illustrates a Spectrally Efficient VoLTE (SE-VoLTE) backhaul system including a mobile satellite network, according to various embodiments.

In some places, the geographical distance between the eNB 254 and a terrestrial or core network (208) is so large, that the traffic between the eNB 254 and the CN 208 is carried over a satellite network. This is called Cellular Backhaul over Satellite (CBoS). The SE-VoLTE for AMR can also be applied at the satellite link between a VSAT 220′ and a satellite gateway 240′.

In some embodiments, voice traffic between an eNB 254 and a terrestrial or core network 208 is carried via a GPRS Tunneling Protocol (GTP) tunnel over a backhaul system 200′. In a GTP tunnel communicated via the forward link 210 and the return link 212, each traffic flow is associated with a QoS Control Indicator (QCI) value. The QCI may determine a priority of the traffic. Voice traffic is usually assigned with a QCI associated with high priority. However, traffic priority inside the GTP tunnel may only be known by the eNB 254 and a CN endpoint 208 (for example, an EPC), and as such, the traffic priority over the backhaul network (the forward link 210 and the return link 212) is not visible.

To allow traffic prioritization on the backhaul, usually the eNB 254 and the CN endpoint map a traffic priority to a DSCP value on the Internet Protocol (IP) header. An IP header carrying voice payload is usually populated with a DSCP value corresponding to Expedited Forwarding (EF). In some embodiments, a VSAT 220′ and a gateway 240′ can recognize the voice traffic by looking at the DSCP value. On the backhaul network (the forward link 210 and the return link 212), the AMR rate is recognized by a combination of FEC and color-coding CRC. The eNB 254 may be connected to the VSAT 220′ via a high-speed non-SE-VoLTE link 260. In some embodiments, a link 258 may be an OTA link that communicates the voice traffic via SE-VoLTE.

On the return link 212, the VSAT 220′ extracts flows associated with voice traffic. The VSAT 220′ than converts the voice traffic to SE-VoLTE (for example, by removing an AMR header, auxiliary bits and a RTP/UDP/IP header for each voice traffic flow before transmitting it to the GW 240′. The GW 240′ then restores the AMR header, auxiliary bits and RTP/UDP/IP header of the voice traffic before sending it to the core network.

Similarly, on the forward link 210, the GW 240′ extracts flows associated with the voice traffic. The GW 240′ then removes the AMR header, auxiliary bits and the RTP/UDP/IP header for each traffic flow before transmitting it to the VSAT 220′. The VSAT 220′ then restores the AMR header, auxiliary bits and RTP/UDP/IP header of the voice traffic before sending it to the eNB. The backhaul system 200′ reduces the voice traffic size on the satellite link (the forward link 210 and the return link 212), thus increasing a satellite link's traffic capacity.

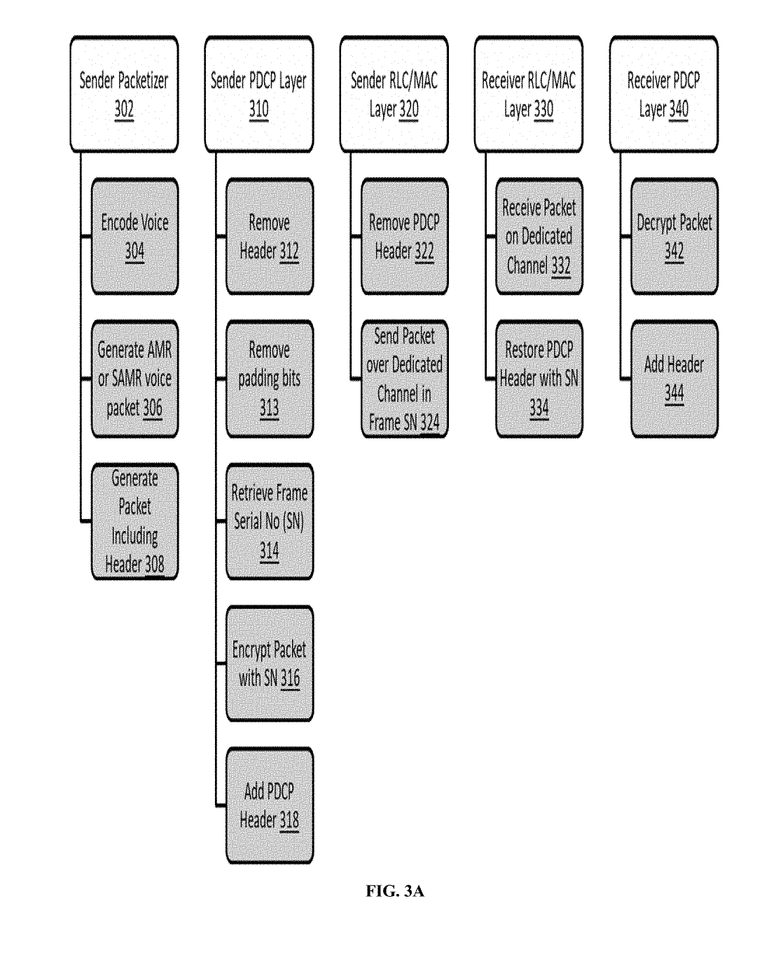

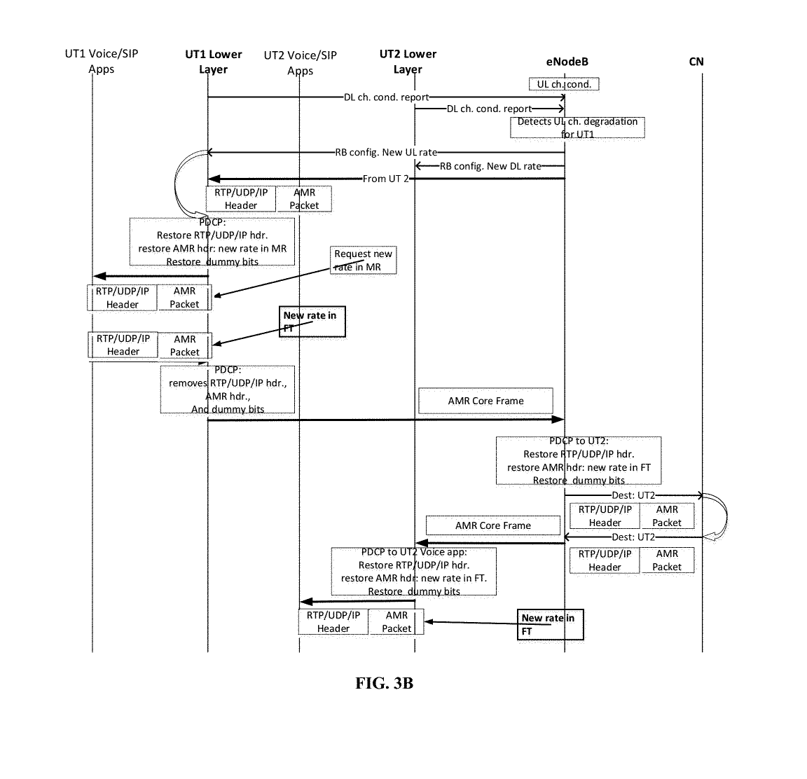

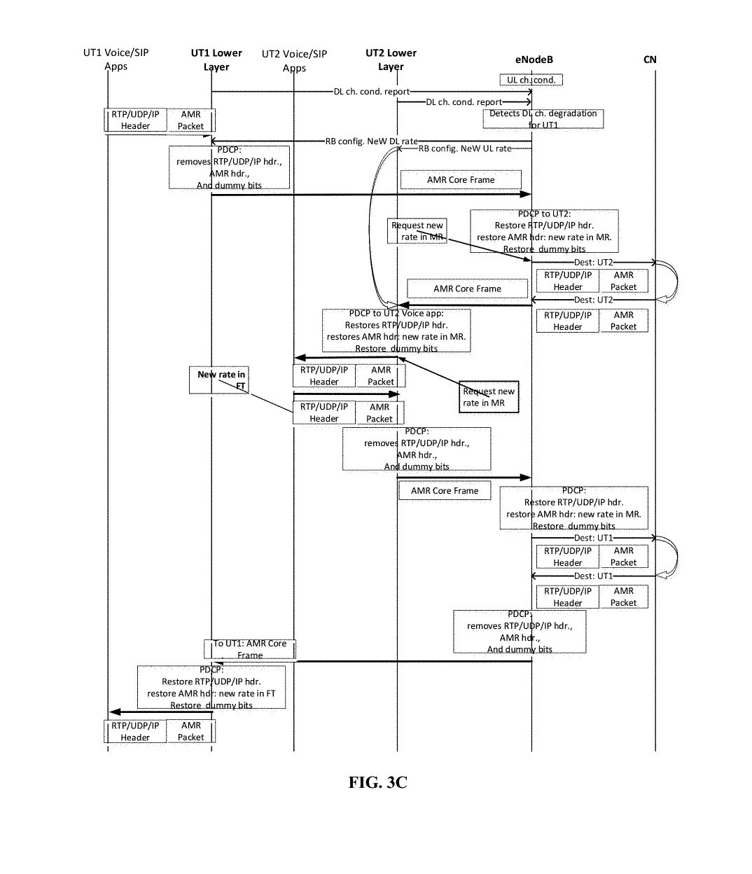

FIG. 3A illustrates a process along a voice path from an encoder to a decoder using the SE-VoLTE protocol, according to various embodiments.

A process 300 along a voice path from an encoder to a decoder using the SE-VoLTE protocol is described. The process 300 may be spread across a sender packetizer 302, a sender PDCP layer 310, a sender RLC/MAC layer 320, a receiver RLC/MAC layer 330, a receiver PDCP layer 340 and a receiver voice application (not shown). To optimize the OTA transmission, several physical layer (PHY) bursts need to be created. The number of the physical layer bursts may not equal the number of supported vocoder rates. Only few physical bursts, usually numbering less than the number of the vocoder rates, are created. The identification of a vocoder rate is determined by examining a Cyclic Redundancy Check (CRC) and/or a Forward Error Correction (FEC) applied to the voice or vocoder payload. Each vocoder rate payload may be color-coded with the CRC and then protected by the FEC. The FEC rate is chosen such that the total number of bits for a rate at the physical layer fits into one of the physical layer bursts.

A sender packetizer 302 may operate to encode voice 304, generate an AMR or SAMR packet, and generate a packet including header 308. The encode voice 304 may be performed by an encoder, for example, an AMR encoder. The header may include an RTP/UDP/IP header and an AMR header.

When the sender PDCP layer 310 at the transmit side receives an IP voice packet from the sender packetizer 302 (application layers), the sender PDCP layer 310 removes the RTP/UDP/IP headers 312 and extracts the voice payload. For an AMR codec, the PDCP then removes the AMR header, auxiliary information, and padding bits 313. Only the AMR core frame (voice payload) is preserved. A packet from an SAMR codec does not include a header, auxiliary information and padding bits.

In some embodiments, the sender PDCP layer 310 then retrieves a frame Sequence number (SN) in which the voice payload with be transported OTA. In the prior art, a PDCP encryptor uses a COUNT parameter. In the present teachings, a TDMA frame number is provided by the lower layers and is used as SN and SN is used to derive COUNT which is used encrypt the voice payload in 316. The encrypted voice payload, i.e., AMR core frame or SAMR payload, is put in the PDCP PDU. The sender PDCP layer 310 adds a PDCP header 318 and forwards the PDCP PDU to the sender RLC/MAC layer 320.

The sender RLC/MAC layer 320 receives the PDCP PDU and removes the PDCP header 322. The sender RLC/MAC layer 320 then forwards the voice packet containing only the voice payload to a physical layer (not shown) (PHY) to place the voice packet in the frame of the dedicated channel that has been assigned to this packet. In some embodiments, the dedicated channel may be designed to carry voice payload with a pre-defined packet size. In some embodiments, the AMR-WB mode-set may be limited to 12.65 kbps, 8.85 kbps and 6.60 kbps. In some embodiments, the AMR-NB mode-set may be limited to 12.2 kbps, 7.4 kbps and 4.75 kbps.

On the receive side, the PHY demodulates and extracts the voice packet based on the FEC and CRC of the channel. If there is no error, the voice packet is forwarded to the receiver RLC/MAC layer 330. The receiver RLC/MAC layer 330 receives the encrypted voice packet over the dedicated channel 332, adds the PDCP header (including PDCP SN) 334 and forwards the encrypted packet with PDCP Header (PDCP PDU) to the receiver PDCP layer 340.

For a AMR codec voice payload, the receiver PDCP layer 340 decrypts the voice payload of the packet 342, selects an RTP/UDP/IP header decompression context to re-create RTP/UDP/IP, recreates the AMR header, auxiliary information and padding bits. The CRC is re-calculated. For SAMR, only RTP/UDP/IP header is re-created in 344. The header and voice payload are forwarded to the receiver voice application. When the receiver is a UT, the receiver voice application may play the voice payload. When the receiver is an eNodeB, the VoLTE packet may be forwarded by the receiver PDCP layer 340 to a destination party to a terrestrial network gateway (not shown).

FIG. 3B illustrates a rate change in a return (UL) link, according to various embodiments.

If an eNodeB determines that the rate in the return (UL) link needs to be changed, i.e. rate is decreased or increased, the eNodeB sends an RRC reconfiguration to the UT regarding the rate changes. The UT's PDCP layer, for example, the sender PDCP layer 310, is informed about the rate change to populate the MR field with the desired new rate. The AMR encoder then changes the rate for the next voice frames. See FIG. 3B.

FIG. 3C illustrates a rate change in a forward (DL) link, according to various embodiments.

If the eNodeB determines that the forward (DL) link rate needs to be changed, i.e. rate is decreased or increased, the receiver PDCP layer 340 at the eNodeB is informed with the new rate. The receiver PDCP layer 340 then populates the MR field with a new rate before forwarding the AMR packet to the destination party via the terrestrial network. See FIG. 3C.

If there are AMR voice packets include an indicating MR with a new rate, the PDCP layer notifies a RRC layer (not shown) to send a RRC reconfiguration to the UT regarding the new rate. The PDCP layer at the UT is informed regarding the rates change and thus populates the MR in the auxiliary header with the desired new rate before sending it to the AMR application layer. The AMR encoder then reduces the rate for the next voice frame.

If the rate change should be applied on both return link and forward links, the eNodeB will execute the two methods above. The AMR rates at forward and return links are independent, i.e. forward and return links may use different AMR rates. Also, if necessary, the rate upgrade and downgrade might be applied on forward and return links simultaneously. Similar method is also used to change the rate of the SAMR codec.

During call setup, a communications protocol for signaling and controlling multimedia communication sessions in applications of Internet telephony for voice and video calls, such as Session Initiation Protocol (SIP), may list the vocoder rates. This rate may be described in the SDP of the SIP voice signaling. When the SIP signal is to a destination in a terrestrial network, the procedures will be the 3GPP standard SIP call setup procedures. For example, a P-CSCF IMS will send the requested rate to a PCRF so that PCRF can setup the dedicated bearer (LTE-EPC dedicated bearer) for the voice session. If the dedicated bearer with the requested rate cannot be accepted by the eNodeB, the dedicated bearer will be modified to accommodate the acceptable rate. The P-CSCF then will forward the SIP signaling to the called party. If the called party cannot accept the offered maximum rate, as indicated by the SIP Session Progress SDP, the IMS will again requests PCRF to modify the bearer rate. The SIP call setup flow will be shown later.

Hence, when a UT is handed over from the terrestrial network to the satellite network, there might be some rate change if currently a UT is using an AMR rate that is supported by the satellite network. The eNodeB, where the UT is currently communicating with, will start the HO procedure to the Satellite eNodeB. In some embodiments, an additional field added to the HO procedures from the eNodeB to the UT through the eNodeB may indicate the acceptable rates on the satellite network.

To improve the transmission over-the-air and not transmit Frame Type information, few physical layer bursts may be created. The identification of the vocoder rate may be determined by examining the CRC and FEC applied to the vocoder payload. Each vocoder rate payload will be color-coded with CRC and then protected by FEC. The FEC rate is chosen such that the total number of bits for a certain rate at the physical layer will fit into one of the physical layer bursts.

During context initialization, the PDCP at the UT sends an initial IP header context to the PDCP layer at the eNodeB. The initial IP header context includes a static part of the RTP/UDP/IP header. A dynamic part of the RTP/UDP/IP header may be calculated or populated by the PDCP during the voice session. The dynamic part of the RTP/UDP/IP Header that may be generated by the PDCP at the eNodeB includes: a RTP sequence number (SN), a RTP Timestamp (TS) and a UDP checksum. The RTP timestamp may be generated based on the sampling rate of the vocoder and the frame size. As an example, for AMR-NB with a sampling rate of 8 kHz with 40 ms frame size, the RTP timestamp may be increased by 320 every 40 ms frame regardless of whether the frame for the encoder is received or not, for example, because of no transmission during silent period or because of packet loss.

The RTP sequence number may be increased only if there is a packet to be sent. For example, if the last packet sent has RTP SN P, then after that there is a period of silence. After the silent period, the RTP SN is P+1. The reason for this scheme is to avoid the RTCP statistic to generate a report indicating packet loss. The following is an exemplary RTP TS and SN number generation:
Packet N: Timestamp=X, Sequence Number=P
Packet N+1: Timestamp=X+320, Sequence Number=P+1
Packet N+2 and Packet N+3 do not show up
Packet N+4: Timestamp=X+1280, Sequence Number=P+2
Packet N+5: Timestamp=X+1600, Sequence Number=P+3
   As evident, if there are X number of loss packets, the RTP time stamp is increased by (X+1)*320, and the RTP sequence number is increased by 1.

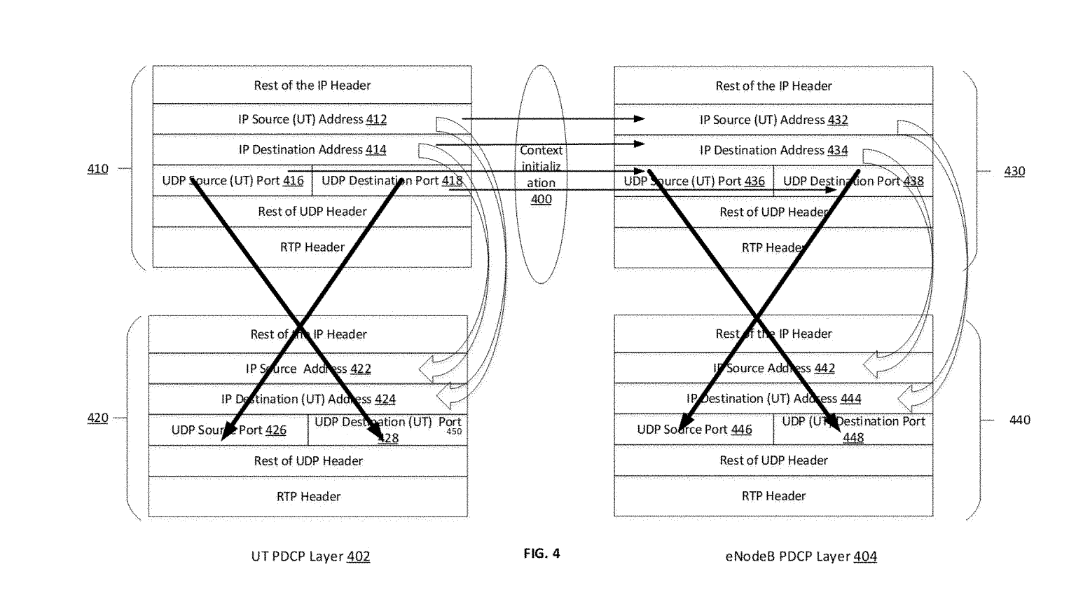

FIG. 4 illustrates an exemplary context initialization of a header context at a receiver with information provided by a sender, according to various embodiments.

A header context initialization 400 at a receiver, for example, an eNodeB, may be initiated by a sender, for example, a UT, providing a header context 410 including an IP source (UT) address 412, an IP destination address 414, a UDP source (UT) port 416, and a UDP destination port 418. The header context 410 is received by the PDCP at eNodeB when it receives an uplink initialization packet to create a HC decompression context 430 for the uplink. The IP source (UT) address 412 is copied to an IP source (UT) address 432. The IP destination address 414 is copied to an IP destination address 434. The UDP source (UT) port 416 is copied to a UDP source (UT) port 436. The UDP destination port 418 is copied to the UDP destination port 438.

During initialization, the PDCP at eNodeB uses the header context 410 to create a compressor header context 440 for the downlink. Here, the PDCP just needs to use the uplink destination IP address packet as its source IP address and the uplink source IP address packet as its destination IP address. With this method, the initialization at the eNodeB can be done without waiting for the first voice packet on the downlink direction to get the RTP/UDP/IP header information. The IP source (UT) address 432 is copied to a IP destination (UT) address 444. The IP destination address 434 is copied to an IP source address 442. The UDP source (UT) port 436 is copied to a UDP (UT) destination port 448. The UDP port 438 is copied to a UDP source port 446.

In some embodiments, the header context 410 is used to create a UT return header context 420. The IP source (UT) address 412 is copied to an IP destination (UT) address 424. The IP destination address 414 is copied to an IP source address 422. The UDP source (UT) port 416 is copied to a UDP destination (UT) port 428. The UDP destination port 418 is copied to a UDP source port 426.

In exemplary embodiments, at a sender/transmit side, the PDCP removes the RTP/UDP/IP header, the AMR header, auxiliary information and padding bits. Only the AMR core frame is kept. At the receive side, the PDCP can infer the rate of the AMR-NB or AMR-WB based on the number of bits received from the lower layer. The PDCP then can regenerate the RTP/UDP/IP header and all the AMR header to construct the full AMR packet. The FQI indicator is always set to “Good Packet” since PHY will drop the errored packet and only deliver good packet to the PDCP layer. When the PHY indicates the receive packet is in error, the FQI may be set based on the indicator provided by the PHY. The CRC can be regenerated by the PDCP based on the Class A bit field of the AMR core frame. The padding bits are inserted to make the AMR packet byte-aligned.

The Mode Request parameter of the AMR header is known by the PDCP since rate change is always initiated by the eNodeB based on a condition information altering the OTA dedicated channel effectiveness. The AMR header reduction and dummy bits removal is applicable to all rates of AMR-NB and AMR-WB.

### SIP Call Setup

SIP call setup follows the 3GPP standard with some modifications to reduce the call setup time. In some embodiments, two modifications may be made to make the call setup more efficient. First, the bearer request by P-CSCF to PCRF is based on the SDP in the SIP INVITE only and does not wait for the response from the called party. The PRACK is sent with session active indication so that there is no need to do SIP update. This can be done since the bearer is already active when the PRACK is sent. Also, the SIP 180 Ringing is sent before the user is alerted to avoid a race condition between SIP 180 Ringing and SIP 200 OK INVITE in case the user answers the ring right away.

In some embodiments, the header context at the originating UT is initialized after SIP 183 Session is received. At the terminating UT, the PDCP header context is initialized the before SIP 183 Session progress is sent. The originating and the terminating UTs send the initial PDCP header context to the eNodeB. This ensures that when the voice packet flows, the PDCP context in the eNodeB have been established both for the originating and terminating UTs.

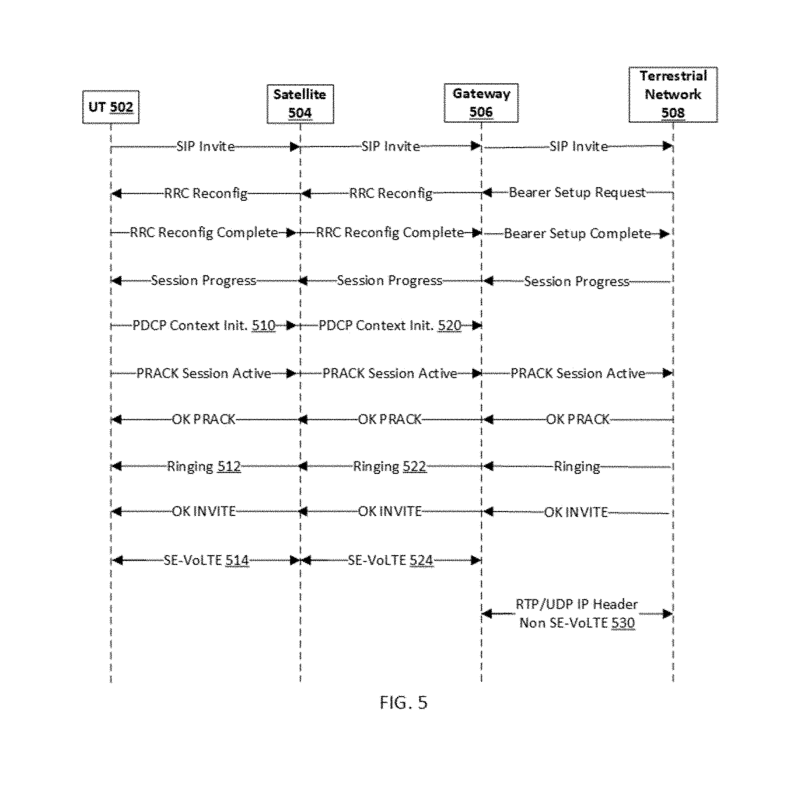

FIG. 5 illustrates an exemplary call flow for an originating UT, according to various embodiments.

For an Originating UT call flow 500, an originating UT 502 sends a SIP INVITE via a satellite 504 and a gateway/eNodeB 506 to a terrestrial network 508. The terrestrial network 508 requests a new dedicated bearer (LTE-EPC dedicated bearer) for a voice call to the UT via eNodeB 506 when a SIP INVITE is received, and the bearer is setup based on the SDP content of the SIP INVITE. The terrestrial network 508 then commands the eNodeB 506 to request a dedicated bearer setup for the originating UT 502. Upon a successful setup of the connection in response to the SIP INVITE, a PDCP context initialization 510 is communicated to the eNodeB 506 as PDCP context initialization 520, and SE-VoLTE 514 traffic is communicated between the originating UT 502 and the eNodeB 506 via the satellite 504 as SE-VoLTE 524. The eNodeB 506 restores a header for the SE-VoLTE voice 524 to communicate a non-SE-VoLTE 530 that is destined for the terrestrial network 508. Conversely, the eNodeB 506 removes a header of the non-SE-VoLTE 530 that is destined for the originating UT 502 as the SE-VoLTE 524.

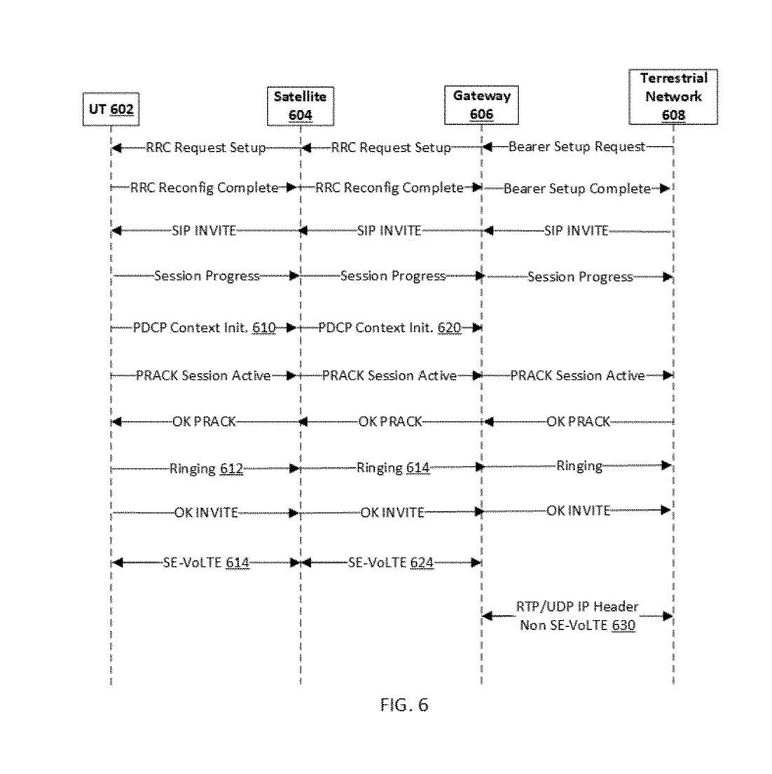

FIG. 6 illustrates an exemplary call flow for a terminating UT, according to various embodiments.

For a Terminating UT 602, a terrestrial network device 608 requests a new dedicated bearer (LTE-EPC dedicated bearer) for a voice call to the UT 602 when a SIP INVITE is received, and the bearer is setup based on the SDP content of the SIP INVITE. The terrestrial network 608 then commands the gateway 606 to request dedicated bearer setup for a terminating UT 602. The requested bearer sets up can be used to page the terminating UT 602 if it is in idle state. The paging can be escalated to a high penetration alerting (HPA) if the terminating UT 602 does not answer the normal paging because it is in a disadvantaged area, such as in the building. Upon a successful setup of the connection in response to the SIP INVITE, a PDCP context initialization 610 is communicated to the gateway 606 as PDCP context initialization 620, and SE-VoLTE 614 traffic is communicated between the terminating UT 602 and the gateway 606 via the satellite 604 as SE-VoLTE 624. The gateway 606 restores a header for the SE-VoLTE 624 to communicate a non-SE-VoLTE voice 630 that is destined for the terrestrial network 608. Conversely, the gateway 606 removes a header of the non-SE-VoLTE voice 630 that is destined for the terminating UT 602 as the SE-VoLTE voice 624.

### Vocoder Rate Change for AMR Type Vocoder

A call flow may be subject to a vocoder rate change on a downlink (DL) on an OTA channel for a call between two user terminals, for example, UT 1 and UT 2. This DL vocoder rate change call flow also applicable when the UT 1 is communicating with a terrestrial network, for example, through a Media Gateway (MGW).

To aid in this, each UT reports DL channel condition to an eNodeB. The eNodeB monitors an uplink (UL) channel condition for each UT. The eNodeB receives a report that the DL for UT 1 has degraded and that a new rate is required to close the link for the UT 1 DL. The eNodeB notifies UT 1 regarding the new rate on the DL. The eNodeB notifies UT 2 regarding the new rate on the UL. When the eNodeB receives an AMR packet from UT1, the eNodeB PDCP recreates the RTP/UDP/IP header, restores the AMR header and reinserts dummy bits, and the eNodeB PDCP also sets a new rate in the MR field. This packet may be routed to the UT 2 through the eNodeB and a terrestrial network.

When the eNodeB PDCP receives an AMR packet to UT 2, the eNodeB sends RRC reconfiguration message to UT 2 informing a new AMR rate, the eNodeB PDCP removes the RTP/UDP/IP header, removes the AMR header, removes the padding bits, and sends just the voice payload to the UT 2 OTA. When the UT 2 PDCP receives the AMR packet from the eNodeB, the UT 2 PDCP reinstates the RTP/UDP/IP header, restores the AMR header, and puts the new rate in the MR Field based on the new rate. Then, the UT 2 PDCP forwards the restored packet to the UT 2 Voice/SIP applications.

When the UT 2 Voice app generates the next AMR voice packets they will generated with the new rate indicated in FT field. The UT 2 PDCP removes the RTP/UDP/IP header, removes the AMR header and removes the dummy bits. The UT 2 sends the SE-AMR packet to the eNodeB. The eNodeB recreates the RTP/UDP/IP header, the AMR header, the auxiliary information and the padding bits from UT 2 and forwards the restored packet to UT 1 through the terrestrial network. The UT 1 will receive the restored AMR packet with the new rate.

A call flow may be subject to a vocoder rate change on the UL on an OTA channel for a call between two user terminals, for example, UT 1 and UT 2. This vocoder rate change on the UL is also applicable with the same procedures when UT is communicating with a terrestrial network through a MGW. If vocoder rate changes should be done for the DL, the UL and for both UTs, the call flows for vocoder rate changes on the DL and UL may be applied.

When an eNodeB detects a UL channel degradation for UT 1, the eNodeB sends new configuration to the UT 1 to reduce an UL rate with the specified rate. The eNodeB sends a new configuration to the UT 2 including a new rate on its DL. When the PDCP UT 1 receives an AMR packet from the UT 2, it reinstates RTP/UDP/IP header, restores AMR header with new rate specified in MR (the new rate is the rate specified by the eNodeB on step 2), re-inserts dummy bits in the AMR core frame. The voice App UT 1 sends next voice packets with new rate in FT. The UT 1 PDCP removes the RTP/UDP/IP header, removes the AMR header, removes the auxiliary information and removes the dummy bits. The UT 1 PDCP then sends the AMR core frame to the eNodeB. The rest is the same process as when the eNodeB sends a packet to the UT 2.

### Vocoder Rate Change for No-Header Vocoder

The vocoder rate change is also applicable for a vocoder that does not include a header, such as a SAMR vocoder. This kind of vocoder only sends a payload. The rate is inferred from the payload size. The vocoder rate change for this type of vocoder is the same as the vocoder rate change for a AMR vocoder. The only difference is that the vocoder rate change is communicated to the voice encoder by using an RTCP by the eNodeB to the other eNodeB on the terrestrial network or by the PDCP layer to the voice encoder on the UT side.

### Handover Procedures

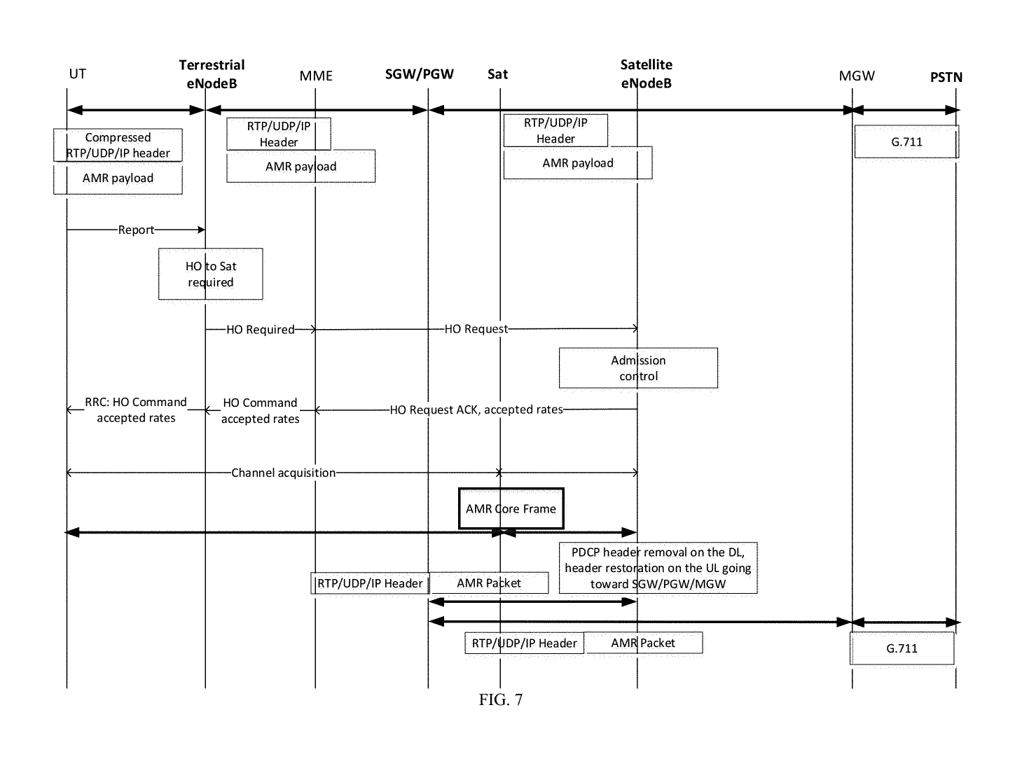

FIG. 7 illustrates a UT handover from a terrestrial network to a Satellite Network according to various embodiments.

Handover can happen from a terrestrial network to a satellite network or vice versa. For simplicity, the MME/SGW/PGW operations do not change. The handover signaling is the S1 handover as defined in 3GPP 23.401 and 36.300. Assume that a UT is having active voice session on the terrestrial network.
When a terrestrial eNodeB, based on a UT report, decides to handover the UT from the terrestrial network to the satellite network, it sends a HO to a satellite eNodeB via, for example, a MME (i.e., a S1-Handover).
If the satellite eNodeB accepts the HO, it will reply with a Handover Request ACK. The satellite eNodeB will include information for the UT to access the Satellite network and the channels that can be accepted. The satellite eNodeB might request to reduce the UT channel for VoLTE. The accepted vocoder rate field can be added to the Handover Request ACK (in the Target to Source Transparent Container).
The terrestrial eNodeB forwards the HO information from the Satellite eNodeB to the UT via a RRC HO command. The UT might be asked to reduce a vocoder rate if the satellite link does not support the rate or if there is no capacity to carry the current UT vocoder rate. The accepted vocoder rate field can be added to the RRC HO command (Target to Source Transparent Container).
The UT accesses the Satellite Network.
After handover, the UT is still served by the same PGW as the anchor. Hence, the UT voice session is not interrupted.
After the UT is accepted to the Satellite network, the Voice packet flow now is through the satellite network. There is no buffering for the voice packet during transition from the terrestrial network to the satellite network.

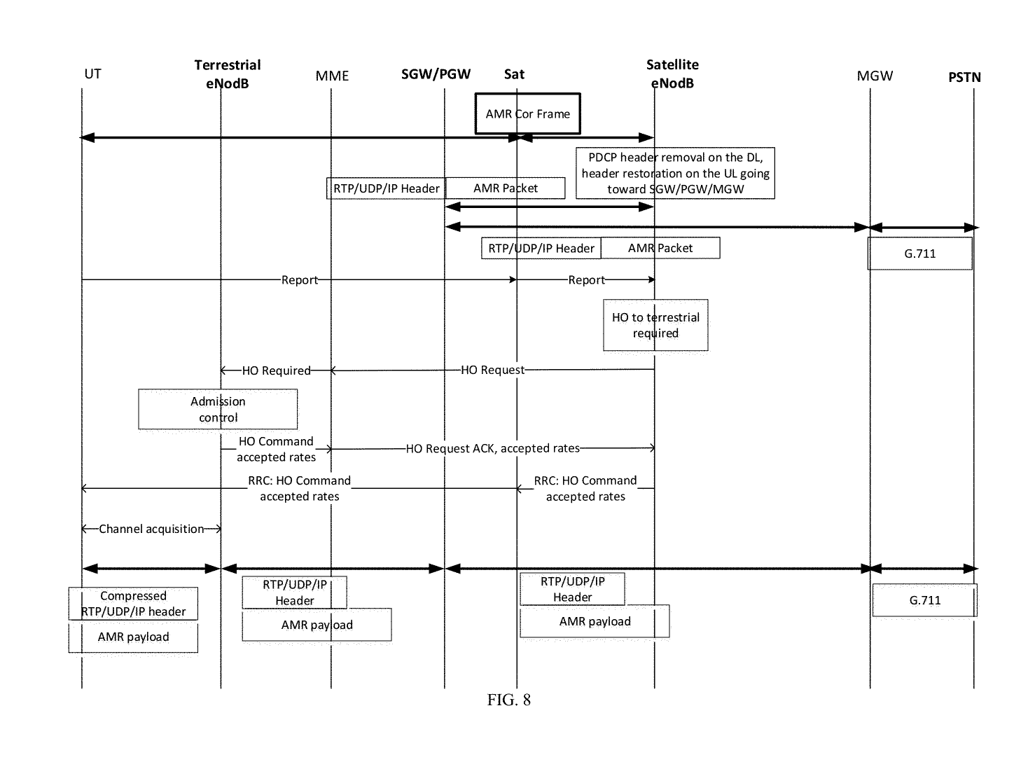

FIG. 8 illustrates a UT handover from a Satellite Network to a terrestrial network.

For simplicity, the MME/SGW/PGW procedures do not change. Handover signaling is 51 handover as defined in 3GPP 23.401 and 36.300. Assume that a UT is having an active voice session on the Satellite network.
When a satellite eNodeB, based on a UT report, decides to handover the UT from the satellite network to the terrestrial network, it sends a required HO to the terrestrial eNodeB via, for example, MME (i.e., S1-Handover).
If the terrestrial eNodeB accepts the HO, it will reply with a Handover Request ACK. The eNodeB will include information for the UT access to the Terrestrial network and bearers that can be accepted. The terrestrial eNodeB might inform the possible UT bearer for VoLTE. The accepted vocoder rate field can be added to a Handover Request ACK (in the Target to Source Transparent Container).
The satellite eNodeB forwards the HO information from the terrestrial eNodeB to the UT via a RRC HO command. The accepted vocoder rate field can be added to the RRC HO command (Target to Source Transparent Container).
The UT accesses the Terrestrial Network.
After handover, the UT is still served by the same PGW as the anchor. Hence, the UT voice session is not interrupted.
After the UT is accepted to the terrestrial network, the Voice packet flow now is through terrestrial network. There is no buffering for a voice packet during transition from the satellite network to the terrestrial network.
The UT handover from the terrestrial network to the satellite network or vice versa is also possible with MME and/or SGW change, but not PGW.

### Dedicated Channel

To facilitate the SE-VoLTE, a dedicated (physical) channel for a specific vocoder rate may be created. The number of the dedicated channels is less than the number of the vocoder rates. A dedicated channel may be assigned. For every voice payload, there may be an X-bit CRC added for color-coding. The voice payload and the CRC color code may be protected by a FEC with the FEC rate such that the total number of bits fit into one of the available physical layer burst.

The receiver may FEC decode the received physical layer burst and then check the CRC. The receiver may work through multiple hypothesis to find the actual vocoder rate transmitted in this burst. The hypothesis that passes the CRC check indicates the vocoder rate. For examples, for 12.2 kbps AMR-NB there is a voice payload of 244 bits for every 20 ms at the physical layer. If 16-bit CRC color code is used, then there will be 260 bits. If a physical bursts of size 390 bits has been created, a FEC with rate of 2/3 is chosen so that the final total number of bits is 390 bits. If the vocoder rate needs to be changed during the voice session, the voice payload for the new rate might be carried in a different physical layer burst.

### SIP Call Setup for Supplementary Service

When a UT supports supplementary services, a header context has to be re-initialized. In some embodiments, a supplementary service may require the UT to talk to another party while the UT is still in active session, for example, during call waiting. For example, UT 1 is in active session with UT 2. A call from a PSTN users comes to UT 1 via a terrestrial or core network (CN). UT 1 puts UT 2 on hold and then UT 1 answers the call from CN. In exemplary embodiments, before accepting the call from UT 2, UT 1 re-initializes the zero-byte header context at the PDCP at the UT 1 and at an eNodeB. An uplink direction toward the CN needs to be modified and as such the destination IP address for UT 1 may be changed to a Media Gateway (MGW) or the like. On a downlink direction, the source IP address may be changed to the MGW IP address also. Once the PDCP context has been re-initialized, the UT 1 communicates the voice flow between the UT 1 and the MGW. The call between UT 1 and MGW may be communicated via a regular (non-SE-VoLTE) codec.

When UT 1 is finished with the CN user, it sends a SIP BYE to release the call. Before resuming the call with UT 2, the UT 1 re-initializes its PDCP context. On the uplink direction, the destination IP address is changed back to a UT 2 IP address and on the downlink direction the source IP address is changed back to UT 2 IP address. Once the PDCP context has been re-initialized, UT 1 sends a call resume command to UT 2. The call between UT 1 and UT 2 may now be resumed.

Although the subject matter has been described in language specific to structural features and/or methodological acts, it is to be understood that the subject matter in the appended claims is not necessarily limited to the specific features or acts described above. Rather, the specific features and acts described above are disclosed as example forms of implementing the claims. Other configurations of the described embodiments are part of the scope of this disclosure. Further, implementations consistent with the subject matter of this disclosure may have more or fewer acts than as described or may implement acts in a different order than as shown. Accordingly, the appended claims and their legal equivalents should only define the invention, rather than any specific examples given.

We claim as our invention:

1. A method comprising:
providing a dedicated channel between a user terminal and a gateway;
associating the dedicated channel of a voice communication with a header context;
receiving a packet comprising a voice payload of the voice communication over the dedicated channel, wherein the packet does not include the header context;
selecting an associated header context based on the dedicated channel;
generating a header based on the header context; and
sending an IP standard packet comprising the header and the voice payload to a terrestrial network device.

2. The method of claim 1, wherein the gateway comprises an enhanced Node-B (eNodeB), and the dedicated channel comprises an Over-The-Air (OTA) channel providing communication between the user terminal and the enhanced Node-B (eNodeB) via a satellite.

3. The method of claim 1, wherein the gateway comprises a satellite gateway, and the dedicated channel comprises an Over-The-Air (OTA) channel providing communication between a Very Small Aperture Terminal (VSAT) and the satellite gateway via a satellite.

4. The method of claim 1, wherein the generating the header comprises filling at least a portion of a Realtime Transport Protocol (RTP) header, a User Datagram Protocol (UDP) header, or an Internet Protocol (IP) header.

5. The method of claim 4, wherein the voice payload is an encoded data stream and the generating the header comprises filling at least a portion of an encoded data stream header.

6. The method of claim 5, wherein the encoded data stream is encoded by an Adaptive Multi-Rate (AMR) codec, and the header includes an AMR header, an AMR auxiliary information, and AMR padding bits.

7. The method of claim 1, wherein the voice payload is an encoded data stream and the generating the header comprises filling at least a portion of an encoded data stream header.

8. The method of claim 1, further comprising implementing, during an active voice communication, one or more of a supplementary feature, a handover, a vocoder rate selection during handover, a vocoder rate selection during call waiting, a vocoder rate selection during three-way calling, a bearer rate change, or a combination thereof.

9. The method of claim 1, further comprising decrypting a portion of the header, the voice payload or a combination thereof, using a frame number associated with a frame comprising the packet.

10. The method of claim 1, wherein the dedicated channel comprises a plurality of dedicated channels each associated with a vocoder rate, and the method further comprises changing the vocoder rate based on a condition of the dedicated channel during an active voice communication.

11. A method comprising:
providing a dedicated channel between a user terminal and a gateway;
associating the dedicated channel of a voice communication with a header context;
receiving an IP standard packet comprising a header and a voice payload from a terrestrial network device;
selecting a selected dedicated channel from the dedicated channel based on an association between the header and the header context;
updating the header context based on the header; and
sending a packet comprising the voice payload over the selected dedicated channel, wherein the packet does not include the header.

12. The method of claim 11, wherein the gateway comprises an enhanced Node-B (eNodeB), and the dedicated channel comprises an Over-The-Air (OTA) channel providing communication between the user terminal and the enhanced Node-B (eNodeB) via a satellite.

13. The method of claim 11, wherein the gateway comprises a satellite gateway, and the dedicated channel comprises an Over-The-Air (OTA) channel providing communication between a Very Small Aperture Terminal (VSAT) and the satellite gateway via a satellite.

14. The method of claim 11, further comprising encrypting a portion of the header, the voice payload or a combination thereof, using a frame number associated with a frame comprising the packet.

15. The method of claim 11, wherein the header context comprises a rate, the dedicated channel comprises a plurality of channels and the selecting comprises selecting an associated channel based on the rate.

16. The method of claim 11, wherein
the generating the header comprises filling at least a portion of a Realtime Transport Protocol (RTP) header, a User Datagram Protocol (UDP) header, or an Internet Protocol (IP) header,
the voice payload is an encoded data stream encoded by an Adaptive Multi-Rate (AMR) codec, and
the generating the header comprises filling at least a portion of an AMR header, an AMR auxiliary information, and AMR padding bits.

17. The method of claim 11, further comprising implementing, during an active voice communication, one or more of a supplementary feature, a handover, a vocoder rate selection during handover, a vocoder rate selection during call waiting, a vocoder rate selection during three-way calling, a bearer rate change, or a combination thereof.

18. A system comprising:
a gateway; and
a dedicated channel for voice communication connected to the gateway;
wherein the gateway
associates the dedicated channel with a header context,
receives a packet comprising a voice payload of the voice communication over the dedicated channel, wherein the packet does not include the header context,
selects an associated header context based on the dedicated channel,
generates a header based on the header context, and
sends an IP standard packet comprising the header and the voice payload to a terrestrial network device.

19. The system of claim 18, wherein the dedicated channel comprises a plurality of dedicated channels each associated with a vocoder rate, and the gateway changes the vocoder rate based on a condition of the dedicated channel.

20. The system of claim 18, wherein the gateway is configured to
the voice payload is an encoded data stream, and
the gateway is configured to fill the header with at least a portion of a Realtime Transport Protocol (RTP) header, a User Datagram Protocol (UDP) header, an Internet Protocol (IP) header, or an encoded data stream header.

21. A system comprising:
a gateway; and
a dedicated channel for voice communication connected to the gateway;
wherein the gateway
associates the dedicated channel with a header context,
receives an IP standard packet comprising a header and a voice payload from a terrestrial network device,
selects a selected dedicated channel from the dedicated channel based on an association between the header and the header context,
updates the header context based on the header, and
sends a packet comprising the voice payload of the voice communication over the selected dedicated channel, wherein the packet does not include the header.
